(19) United States
(12) Patent Application Publication
(10) Pub. No.: US 2007/0163727 A1
(43) Pub. Date: Jul. 19, 2007

(54) Window Blinds with Gears

(75) Inventors: Li-Ming Cheng, Kaohsiung (TW); Kuei-Lin Tsai, Kaohsiung, NY (TW)

Correspondence Address: WPAT, PC;INTELLECTUAL PROPERTY ATTORNEYS, 2030 MAIN STREET, SUITE 1300, IRVINE, CA, 92614, US

(73) Assignee: ZIPSHADE INDUSTRIAL (B.V.I.) CORP., Tortola (VG)

(21) Appl. No.: 11/687,590

(22) Filed: Mar. 16, 2007

Related U.S. Application Data
(63) Continuation-in-part of application No. 11/090,590, filed on Mar. 28, 2005.
Application No. 11/090,590 is a continuation-in-part of application No. 10/743,178, filed on Dec. 23, 2003.
Application No. 10/743,178 is a continuation-in-part of application No. 10/623,776, filed on Jul. 21, 2003, now Pat. No. 6,837,294.
Application No. 10/623,776 is a continuation-in-part of application No. 10/360,305, filed on Feb. 10, 2003, now Pat. No. 6,991,020.

(51) Int. Cl. E06B 9/30

(52) U.S. Cl. 160/170

(57) ABSTRACT

A window covering system with geared interconnecting mechanism for raising and lowering window shade cordlessly. The window covering system may have at least one lifting cord, at least one connecting cord, an elongated member having a channel, and window covering member which may be a shade, a blind, or other known window covering designs. The contemplated device has at least one spring-actuated rotary element coupled to a spring and having a spool capable of winding and storing at least one connecting cord. The rotary elements are interconnected with gears for precision rotation, and are contained within a receptacle detachably received within the channel of the elongated member. This window covering system may optionally include a rotor set having rotors optionally interconnected by gears.

### CROSS-REFERENCE TO RELATED APPLICATIONS

This application is related to co-pending application entitled “CORDLESS BLINDS WITH SECONDARY BLIND ADJUSTMENT MEANS,” filed on the same day as the instant application, and this application is a continuation-in-part of U.S. patent application Ser. No. 11/090,590, filed on Mar. 28, 2005, now pending, which is a continuation-in-part of U.S. patent application Ser. No. 10/743,178, filed on Dec. 23, 2003, now pending, which is a continuation-in-part of U.S. Pat. No. 6,837,294, issued on Jan. 04, 2005, and which is a continuation-in-part of U.S. Pat. No. 6,991,020, issued Jan. 31, 2006, all of which are hereby incorporated by reference in their entirety.

Although incorporated by reference in its entirety, no arguments or disclaimers made in the parent application apply to this divisional application. Any disclaimer that may have occurred during the prosecution of the above-referenced application(s) is hereby expressly rescinded. Consequently, the Patent Office is asked to review the new set of claims in view of all of the prior art of record and any search that the Office deems appropriate.

### FIELD OF THE INVENTION

The field of the invention is window coverings, more particularly to geared mechanism for providing height adjustment in cordless window shades and/or cordless window blinds.

### BACKGROUND OF THE INVENTION

Typical Corded Venetian blinds pose a danger to child and small pets. Increasing number of child strangulation incidents due to corded blinds has raised public awareness for years. As a result, there have been efforts in developing cordless window blinds. Kurhar (U.S. Pat. No. 5,482,100, all of which is herein incorporated by reference in its entirety) provides a cordless blind in a simple design with the goal of having few component parts, eliminating relative complex parts typically found in Venetian blinds. In Kuhar, a consistent variable force spring motor is used to replace typical parts necessary in a corded shade, namely, a pulley system, a manual pull cord, and cord locking mechanism.

However, using such consistent variable force spring motor by itself to counterbalance the weight of the shade has numerous disadvantages. For example, relatively large and strong metal springs are needed to provide sufficient counterbalance force in such design where the spring alone is to counterbalance the weight of the shade. These springs are relatively expensive and thus increase manufacturing cost. Also, it is rather difficult to precisely position the bottom-most part of the shade when adjusting shade coverage, as the shade tends to bounce or retract a little from the position where the user had intended. Thus, there is a continuing need for new cost-effective ways to raise blinds cordlessly with more stabilized and precise positioning ability to address these concerns.

All referenced patents, applications and literatures are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

The invention may seek to satisfy one or more of the above-mentioned desire. Although the present invention may obviate one or more of the above-mentioned desires, it should be understood that some aspects of the invention might not necessarily obviate them.

### SUMMARY OF THE INVENTION

The present invention provides apparatus, systems and methods in which a geared interconnecting mechanism is provided for raising and lowering a window shade cordlessly.

Among the many different possibilities contemplated, the window covering system may have at least one lifting cord, at least one connecting cord, an elongated member having a channel, a rotor set having at least one rotor, and window covering member which may be a shade, a blind, shutters or other known window covering types. The contemplated device has at least one spring-loaded motor which has at least one storage drum, at least one output drum, and at least one spring. The storage drum is capable of winding and storing at least one connecting cord. In further contemplated embodiments, the storage drum and the output drum are capable of entraining at least one connecting cord in a FIG. 8 configuration. Likewise, the connecting cord may wind about just one, or more than one of the drums. Optionally, more than one spring may be used in the motor.

In terms of gears, it is further contemplated that the drums are optionally interconnected with gears for precision rotation. Optionally, the spring-loaded motor can be located within a receptacle detachably and slidably received within the channel of the elongated member. This detachable receptacle allows easy access to components of the spring-loaded motor for repair and adjustment. And in embodiments where the rotor set has a plurality of rotors, some or all of the rotors may be optionally interconnected by gears as well. These rotors wind and/or store and/or entrain lifting cord and connecting cord. The rotors may have parallel axes which extend in one of the following directions:

i) vertically

ii) horizontally

The rotor set and spring-loaded motor mentioned above are contained in the channel of the elongated member. This elongated member is preferably a head rail. Alternatively, this elongated member can be located at the bottom of the window covering.

Various objects, features, aspects and advantages of the present invention will become more apparent from the following detailed description of preferred embodiments of the invention, along with the accompanying drawing figures in which like numerals represent like components.

### BRIEF DESCRIPTION OF THE DRAWING

FIG. 1 is a frontal elevation view of a first embodiment according to an aspect of the inventive subject matter.

FIG. 2 is a close-up view of the first embodiment according to an aspect of the inventive subject matter.

FIG. 3 is a top plan view taken on line 3-3 of FIG. 2.

FIG. 4 is an enlarged vertical sectional view taken on lines 4-4 of FIG. 2.

FIG. 5 is a view similar to FIG. 2, showing modification.

FIG. 6 is a view showing a second embodiment of the invention.

FIG. 6-1 is a break-away view of the second embodiment in operation.

FIG. 7 is a view showing another embodiment of the invention.

FIG. 8 is a view showing yet another embodiment of the invention.

FIG. 9 is a view showing another embodiment of the invention according to an aspect of the inventive subject matter.

FIG. 10 is a view showing another embodiment of the invention according to an aspect of the inventive subject matter.

FIG. 10-1 is an illustrative view of the spring-loaded motor of FIG. 10.

FIG. 11 is a view showing another embodiment of the invention showing a varied arrangement of the spring, according to an aspect of the inventive subject matter.

FIG. 11-1 is a plan view of FIG. 11 where three rotor elements are coupled together by a two springs.

FIG. 12 is a view showing another embodiment of the invention according to an aspect of the inventive subject matter having two springs.

FIG. 12-1 is a plan view of the spring-loaded motor of FIG. 12.

FIG. 13 is a view showing yet another embodiment of the invention according to an aspect of the inventive subject matter where two springs are present.

FIG. 13-1 is a break-away view showing an embodiment in operation.

FIG. 14 is a view showing another embodiment of the invention according to an aspect of the inventive subject matter.

FIG. 15 is a view showing another embodiment of the invention according to an aspect of the inventive subject matter where two connecting cords are present.

### DETAILED DESCRIPTION

The invention and its various embodiments can now be better understood by turning to the following detailed description of the preferred embodiments, which are presented as illustrated examples of the invention defined in the claims. It is expressly understood that the invention as defined by the claims may be broader than the illustrated embodiments described below.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed herein even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims therefore include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

Thus, the detailed description set forth below in connection with the appended drawings is intended as a description of the presently preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions may be accomplished by different embodiments that the spirit of the invention also intends to encompass.

The inventors have discovered a novel way of providing a cordless window covering system where gears are utilized to connect some of the component parts, reason of which will be discussed in more detail later. In one preferred aspect of the inventive subject matter, the window covering system uses at least one lifting cord to lift the window covering, as is typical in window blinds. A portion of the lifting cords are positioned vertically and passes through the window covering member and connect to a bottom elongated member. The window covering member is contemplated to be a shade (e.g., pleated shade such as roman shades, honey comb shades, or cellular shades) or a shutter (e.g., wooden shutter or Venetian blind). Similar to typical window blinds, to raise the blind, the lifting cords longitudinally moves in the upward direction to lift the bottom elongated member, which may contain weighted metal bars.

Known cordless blinds use a spring-loaded motor to effectuate pulling of the lifting cords. In one prior art, lifting cords are directly wound onto the output drum of the spring-loaded motor. Contemplated embodiments of the current invention use a connecting cord to, pull the lifting cords, a portion of the connecting cord is wound on the output drum of the spring-loaded motor. In operation, the spring-loaded motor pulls the connecting cord, which in turn pulls the lifting cords. In preferred embodiments of the invention, the lifting cords and the connecting cord are not directly connected to each other. In another preferred embodiment, the lifting cords and connecting cord are coupled via rotors, details of which will be discussed later. And in other preferred embodiments, the rotors are connected by gears, details of which will be discussed later.

As a result, a movement in the connecting cord (either to store or to release line from the spring-loaded motor) would cause a movement in the lifting cords, which would in turn raise or lower the blinds.

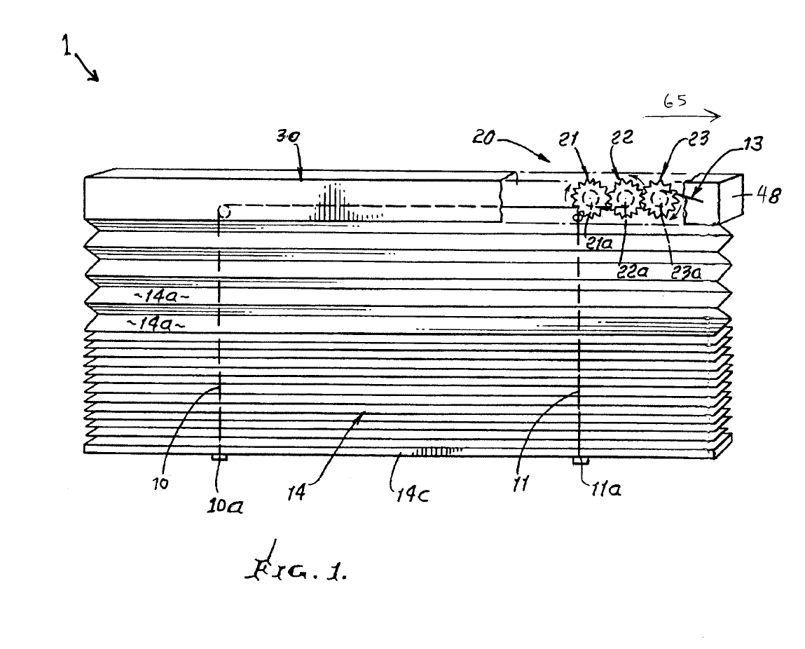

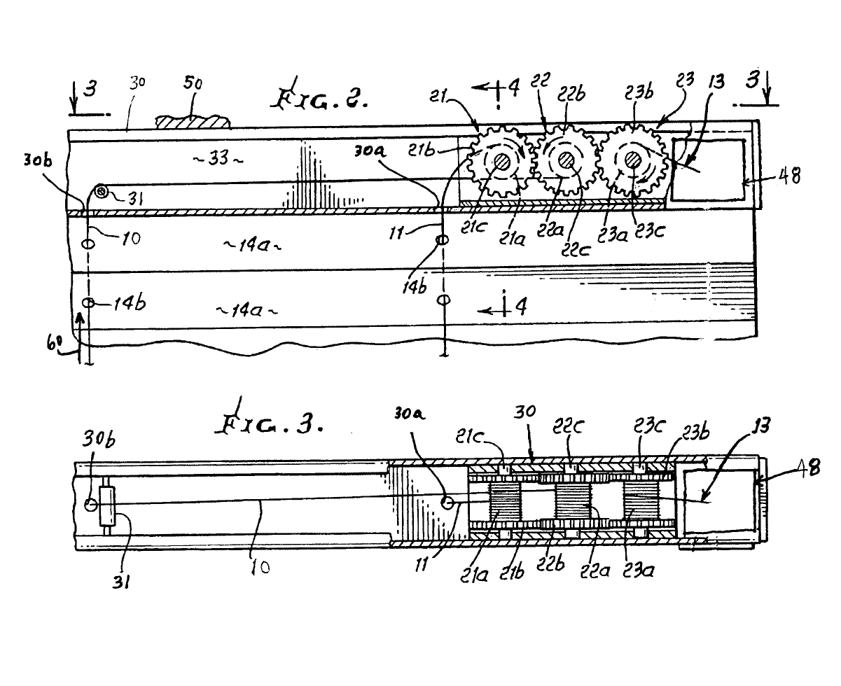

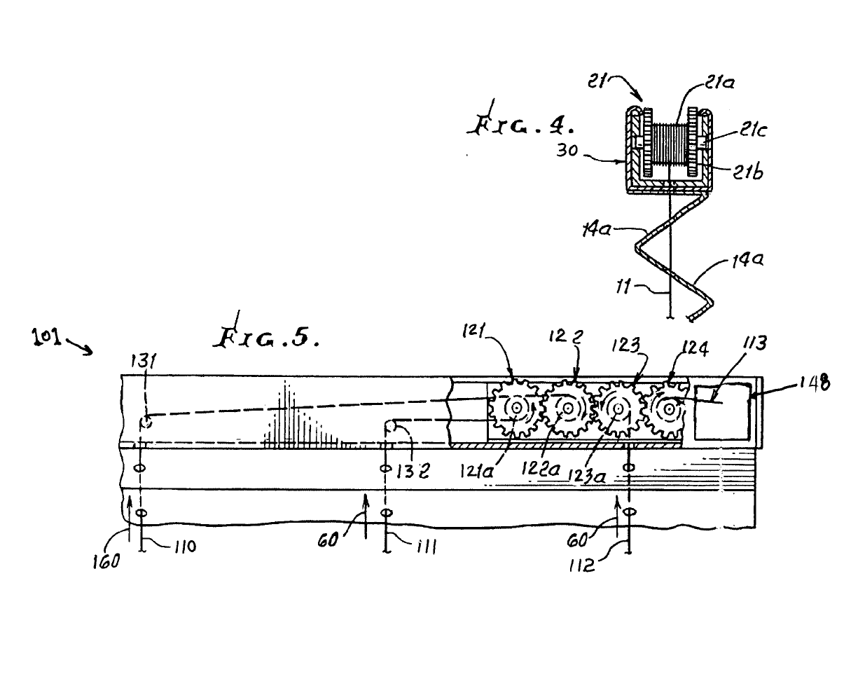

We now refer to the Figures. As is shown in FIGS. 1 and 2, window covering system 1 comprises a head rail 30 fastened to a top part of a window frame 50, a first lifting cord 10 and second lifting cord 11, both of which are movable together to raise and lower the shade 14, a connecting cord 13 leads to a spring-loaded motor 48 which counterbalances the weight of the shade 14 and of the bottom elongated member 14c. The distal ends 10a and 11a of lifting cords 10 and 11 are attached to a bottom elongated member 14c of the shade 14.

Typically, lifting cords 10 and 11 pass through openings 14b in shade slats 14a, but other configurations may be possible. For example, lifting cords may tether to the shade slats 14a on their front or back edges without the need to have openings 14b. When lifting cords 10 and 11 are moved or retrieved upwardly toward the proximal end (arrow 60), the shade progressively collapses in an upward direction, thus decreasing its area of coverage over a window.

The embodiment as illustrated in FIG. 1 has a rotor set 20 disposed within the channel 33 of the head rail 30. The rotor set has three rotors 21, 22, and 23 interconnected by gears having teeth 21b, 22b, 23b. The meshed teeth 21b, 22b, 23b of rotors 21, 22, and 23 are coupled such that when one of the rotors rotates, the other two also rotate correspondingly. The rotors 21, 22, and 23 have spools 21a, 22a, 23a that store and wind lines 10, 11, and 13, respectively. In operation, when a user manually raises the shade by holding and lifting the bottom elongated member 14c up toward the head rail 30, both lifting cords 10 and 11 begin to retrieve upwardly in direction 60, and the spring-loaded motor 48 pulls connecting cord 13 towards a proximal direction 65 and causes rotor 23 to rotate in a clockwise direction. Accordingly, rotor 22 rotates in a counter-clock wise direction to wind and store lifting cord 10 due to its geared coupling with rotor 23. And this in turn causes rotor 21 to rotate in a clockwise fashion to wind and store lifting cord 10 onto its spool 21a. When a user lowers the shade by manually pulling the bottom elongated member 14c downward, the reverse of above actions takes place.

The rotors 21, 22, and 23 have gear teeth 21b, 22b and 23b, with gear teeth 21b meshing with gear teeth 22b, and gear teeth 22b meshing with gear teeth 23b. The rotors and gear teeth being alike. Although gears are preferred, these rotors 21, 22, and 23 may be alternatively interconnected by known mechanical structures other than gears so that rotation of one rotor also causes corresponding rotation of the other two rotors. The preferred gear interconnection provides stability and additional counterbalancing strength to the spring-loaded motor 48. Also, the geared-rotor design allows unison control of multiple lifting cords 10 and 11 by a single connecting cord 13, without direct attachment of the connecting cord to both lifting cords 10 and 11. This arrangement also lowers the risk of line entanglement, as compared to cordless systems where multiple lifting cords are stored and wound on the same storage drum of the spring-loaded motor.

As shown in FIGS. 2 and 3, a minor pulley 31 is provided to redirect lifting cord 10 from a vertical orientation to a horizontal orientation. Minor pulley 31 minimizes scraping of lifting cord 10 along the edges of bore 30b. Lifting cord 10 passes through bore 30b and reaches down to slats 14a and continues to pass through openings 14b. As for lifting cord 11, it may or may not need a similar minor pulley to redirect lifting cord 11 depending on its relative position to bore 30a. In FIGS. 2-4, lifting cord 11 directly feeds from rotor 21 out of head rail 30 and through bore 30a into the shade 14. Rotors 21, 22, and 23 are supported by parallel shafts 21c, 22c, and 23c, respectively.

In FIG. 5, window covering system 101 employs four rotors 121, 122, 123, and 124 interconnected by meshing teeth. This window covering system has three lifting cords 110, 111 and 112, and a connecting cord 113 leading into spring-loaded motor 148. This embodiment operates similarly to that described above.

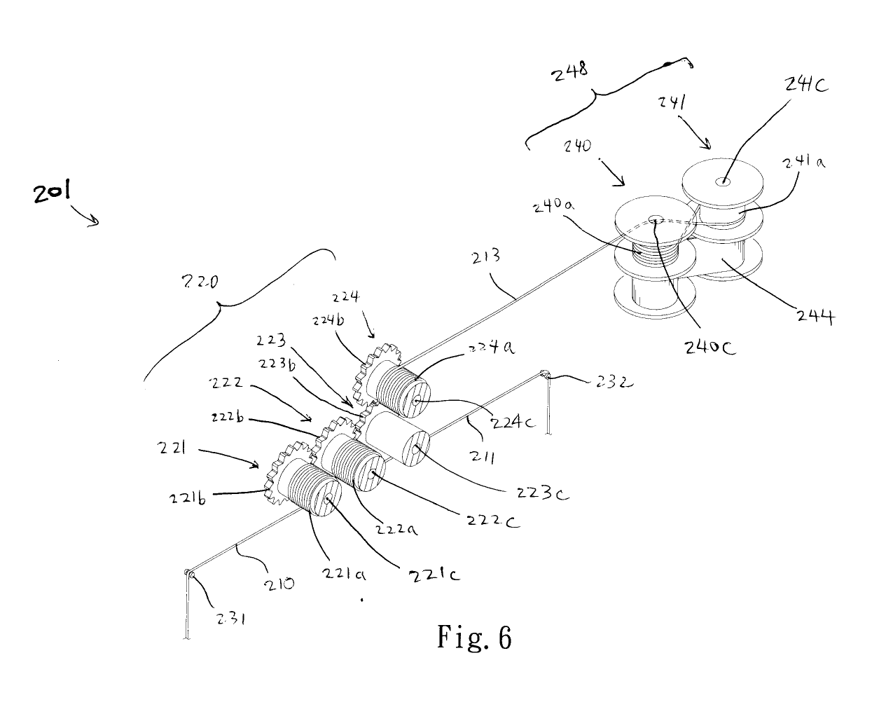

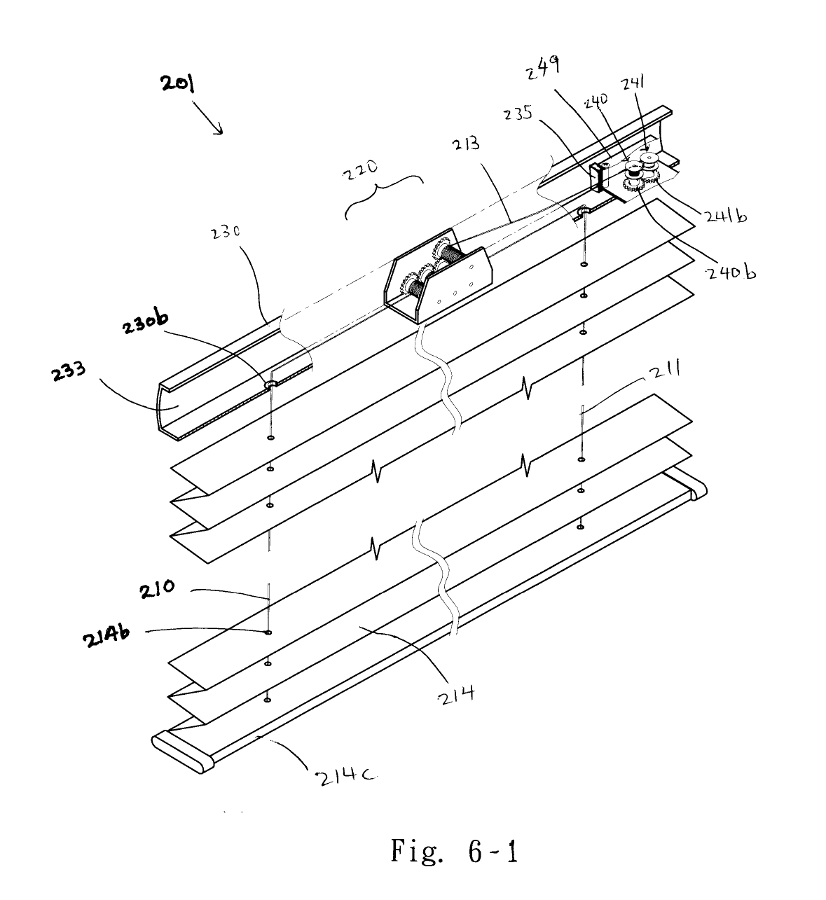

We now refer to FIGS. 6 and 6-1. FIG. 6 illustrates inner components of window covering system 201, and FIG. 6-1 illustrates the entire system in operation. This contemplated embodiment has a spring-loaded motor 248 disposed within an optional receptacle 249 (see FIG. 6-1) which slidably receives within the channel 233. Receptacle 249 can be made of any conceivable material and is preferably made of plastic or metal. Receptacle 249 is not a fully enclosed box and has an opening so that connecting cord 213 can pass through and reach over to rotor set 220 from spring-loaded motor 248. Receptacle 249 is generally shaped to conform to the cross-sectional shape of the channel 233. Having such shape, receptacle 249 slidably fits within the channel 233 of the head rail 230. Further, this receptacle 249 is preferably not fastened onto the head rail 230. Due to biasing force of the spring 244, the connecting cord 113 pulls the receptacle 249 towards the rotor set 220. A block 235 of head rail 230 restrains receptacle 249 from further traveling towards rotor set 220. Block 235 is simply a stationary structure in the channel that keeps the receptacle 249 from moving further towards the rotor set 220. Therefore, the block 235 may be replaced with other similarly functioned structure or parts (e.g., pulley bracket) to restrict further traveling of receptacle 249. Having the detachable receptacle allows consumer to freely slide receptacle 249 out of the channel 233 for maintenance, repair, or replacement of parts. This also presents a novel manufacturing method of mounting a spring-loaded motor on a freely slidable, detachable receptacle 249 that simplifies overall manufacturing steps, thus reduces manufacturing cost.

In some contemplated embodiments, it is advantageous to having the motor connected to the rotor set by the connecting cord, and not directly connected via gear teeth as illustrated in U.S. Pat. Nos. 6,283,192 and 6,293,329 both issued to Toti, all of which are herein incorporated by reference in their entirety. By using a connecting cord, the motor and the rotor set can be relatively easier to be disassembled for repair and maintenance. It is also advantageous to have a slidable receptacle to house the motor, so that the motor can be easily pulled out of the head rail for inspection. And reassembling only requires one to reinsert the receptacle back into the head rail. Easier disassembly of motor from the rotors by using a connecting cord to connect the two is also advantageous because replacement of parts becomes less troublesome.

Again, although the preferred embodiment has detachable receptacle 249, window covering system 201 may also function without receptacle 249. In such embodiments, spring-loaded motor 248 would be mounted directly in channel 233 of head rail 230.

The spring-loaded motor has output drum 240 and storage drum 241 coupled together by an S-shaped spring 244 to bias output drum 240 to rotate in a clockwise direction when looking from top down. These drums 240, 241 are rotatable around axles 240c, 241c, respectively, and these axles 240c, 241c are fastened onto receptacle 249.

Connecting cord 213 leads into spring-loaded motor 248 and entrains around drum surfaces 240a and 241a of output drum 240 and storage drum 241 in a figure-8 (or criss-cross) configuration. Or, the connecting cord may entrain about the two drum in other fashions as disclosed in cross-referenced patents and patent applications. Drum surface 240a winds and stores a portion of the connecting cord 213 in a line-winding direction. Drum surface 241a acts as a pulley to reduce the load on the spring 244. By entraining the connecting cord 213 around drum surface 241a, it supplements a counterbalancing force provided by the spring 244. Spring tension increases as bottom member 214c of shade 214 is lowered, and decreases as bottom member 214c is raised.

This contemplated embodiment has a rotor set 220 disposed in the channel 230a of head rail 230, the rotor set 220 has four liked rotors 221-224 interconnected by gear teeth 221b-224b. The four rotors 221-224 rotate around their respective axles 221c-224c, which parallel each other (but not positioned on the same plane, rather, in a non-planar fashion). Positions of the axles 221c-224c may be adjusted for optimal stability and strength, and may be positioned on the same plane (axles perpendicular to a straight line). Note that there are only two lifting cords 210, 211 in window covering system 201. Rotors 221 and 222 store and wind each of the two lifting cords 210, 211, respectively. Rotor 223 is an intermediary rotor and does not store any lifting cord. It is important to appreciate that although FIG. 6 shows four rotors, contemplated embodiments may include more rotors arranged in linear or non-linear arrangement within channel 230. Also, there may optionally be more than one non-line-storing intermediary rotor similar to rotor 223 in a contemplated rotor set 220. As described previously for spring-loaded motor, the rotor set 220 may also be housed within a similarly detachable receptacle.

Friction in the series of meshing gear teeth 221b-224b, and optionally, friction appropriately provided in the rotors and their axles, assist the counterbalancing action of the spring 244 in compensating the weight of the shade 214 and of the bottom elongated member 214c.

Similar to previously described, when a user raises the shade 214 by manually lifting the bottom elongated member 214c upwards, the rotors 221-224 rotate by pulling force exerted on connecting cord 213 by spring 244. In turn, connecting cord 213 winds onto drum surface 240a.

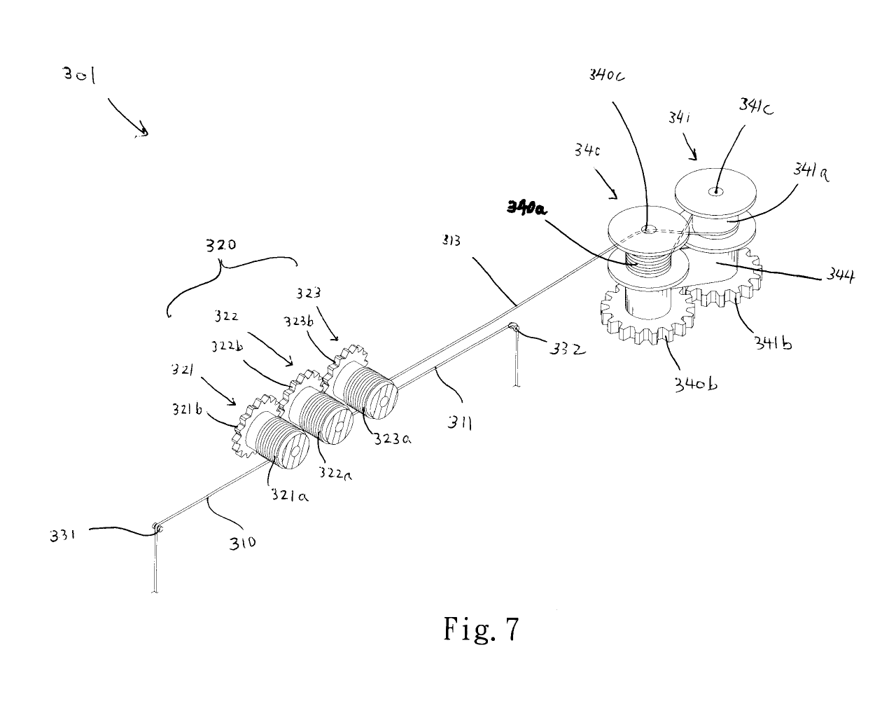

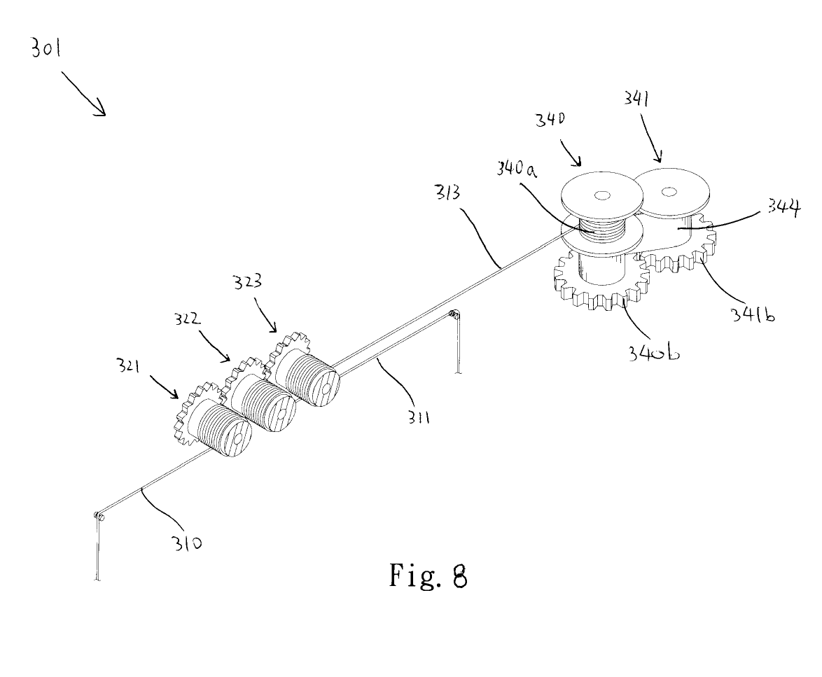

In FIG. 7, connecting cord 313 extends from a rotor set 320 to output drum 340 and storage drum 341, both of which also have interconnecting gears 340b, 341b. Lifting cords 310, 311 extend to and wind about rotors 321, 322, respectively. Connecting cord 313 winds around drum surface 340a, 341a of rotary elements 340, 341 in a FIG. 8 configuration for extra stability. A portion of the connecting cord 313 is stored onto drum surface 340a.

In this embodiment, rotary elements 340, 341 have spur gear mesh-coupling using gear teeth 340b, 341b. Similar to gear teeth 321b-323b, these gear teeth stabilize rotation and counter-balancing force. An S-shaped spring 344 couples the two drums 340, 341 by first winding clockwise about axle 341c and then counterclockwise about axle 340c.

FIG. 8 illustrates a slight variation of the embodiment shown in FIG. 7. Here, storage drum 341 does not have a drum surface as shown in FIG. 7 to entrain the connecting cord 313. As such, connecting cord 313 winds around and stores onto drum surface 340a of the output drum 340 only. It should be appreciated that this variation is possible for all other embodiments disclosed herein. One skilled in the art would immediately appreciate that connecting cord may and may not wrapped around two drum surfaces in a criss-crossed configuration in any of the embodiments disclosed.

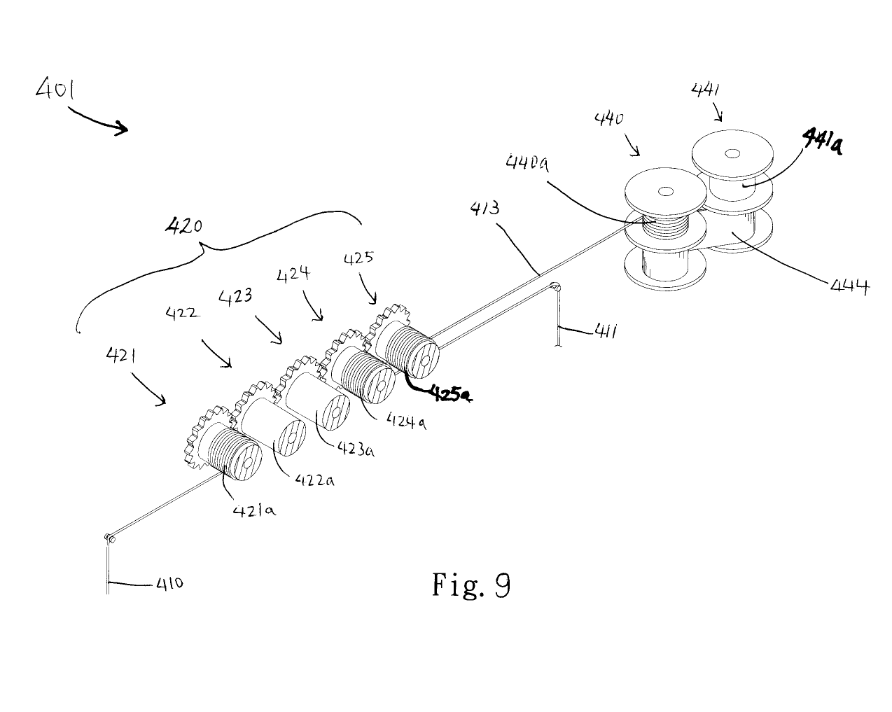

Now referring to FIG. 9, rotor set 420 have five rotors, and output drum 440, and storage drum 441 are arranged similarly to rotary elements 340, 341 of FIG. 6. Here, the two drums 440, 441 do not have gear teeth and the connecting cord 413 does not entrain around both drum surfaces of 440a, 441a. Optionally, connecting cord 13 may wind about the two drum surfaces 440a, 441a in a FIG. 8 configuration. Connecting cord 13 has a distal end that winds and stores onto rotor 425, the rotation of which also causes all other rotors 421-424 to rotate correspondingly. As for the lifting cords 410 and 411, their proximal ends wind and store on rotors 421a and 424a, respectively. Notice that rotors 422, 423 act as intermediary rotors and do not wind any lines. One of ordinary skill in the art would immediately appreciate that these intermediary rotors may be modified to wind and store additional lifting cord, if necessary.

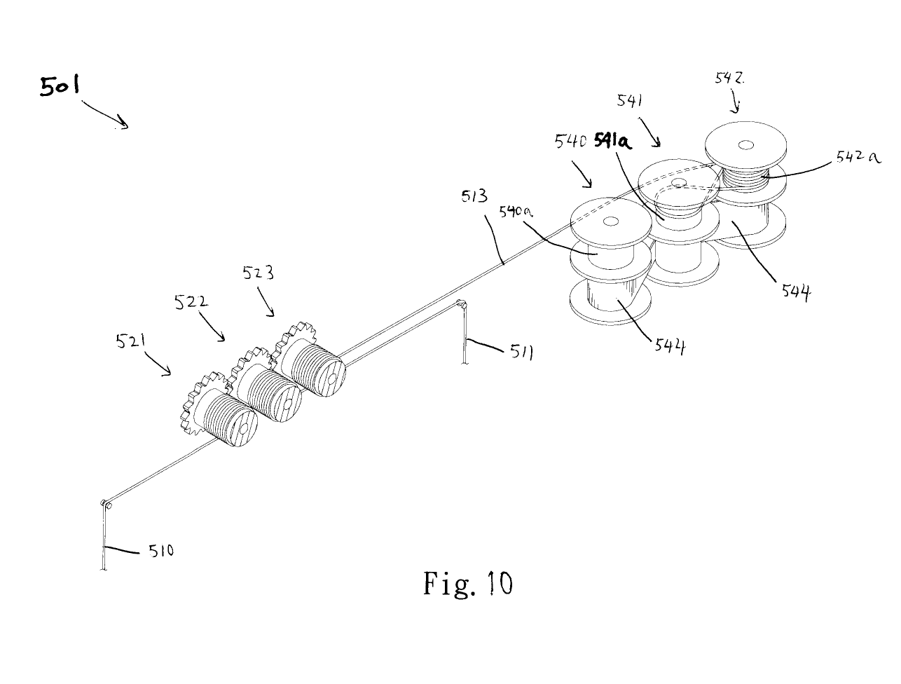

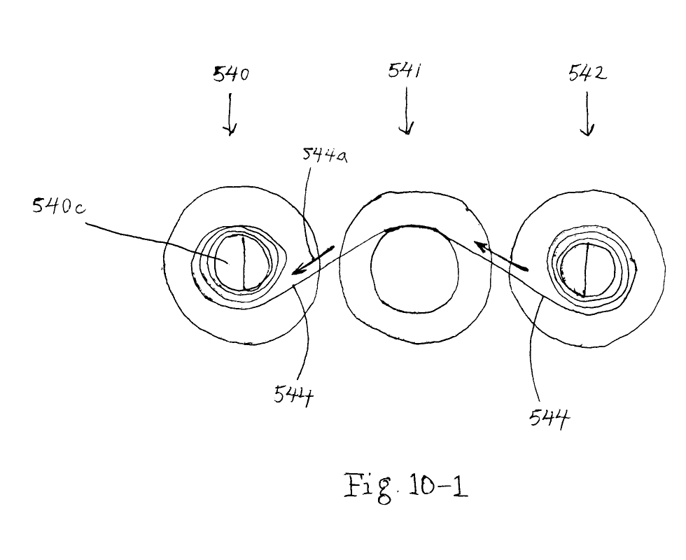

FIGS. 10 through 13 illustrate embodiments having three rotary elements in their spring-loaded motor.

In FIGS. 10 and 10-1, the spring-loaded motor has three drums 540-542. A single spring 544 drives output drum 542 to wind connecting cord 513. Spring 544 forms an S-shape as to its configuration around drums 540, 541, and forms a reverse S-shape as to its configuration around drums 541, 542. Spring has one end attached to axle 540c and tends to retrieve in the direction of arrow 544a, thus biasing output drum 542 to rotate clockwise. The middle drum 541 bends the spring and causes the spring to change direction of travel. This single spring design spanning across three rotary elements provides improved strength and improved counterbalancing force.

As shown in FIG. 10, connecting cord 513 extends from rotor 523 and reaches first to the farthermost output drum 542, wraps around drum surface 542a and then to drum surface 541a, and returning to drum surface 542a to store, creating a criss-cross pattern. As discussed earlier, this configuration is desirous as it assists the counterbalancing function of the spring-loaded motor.

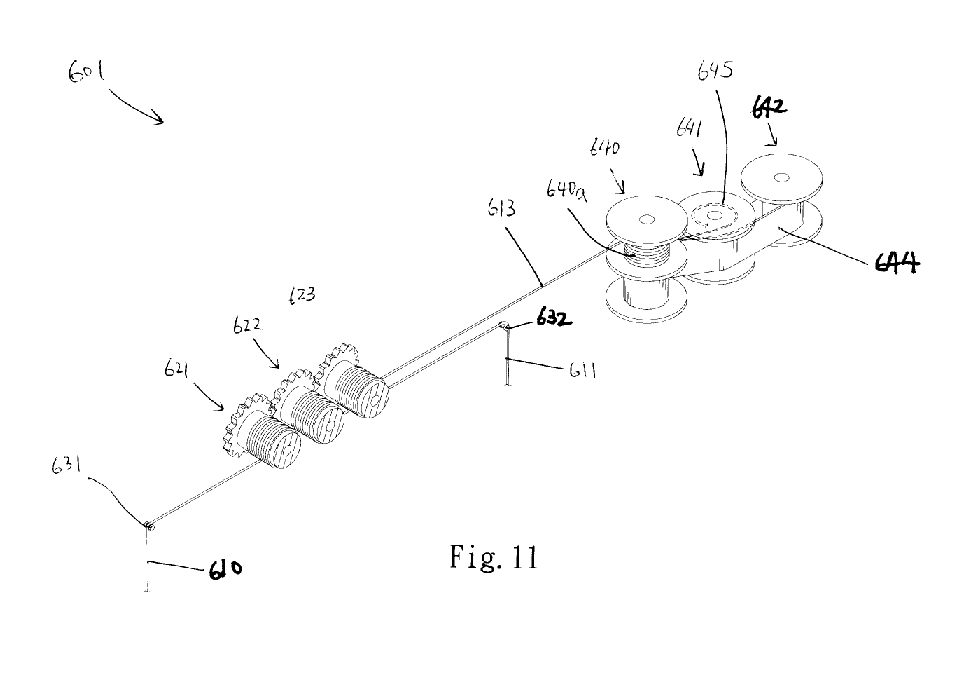

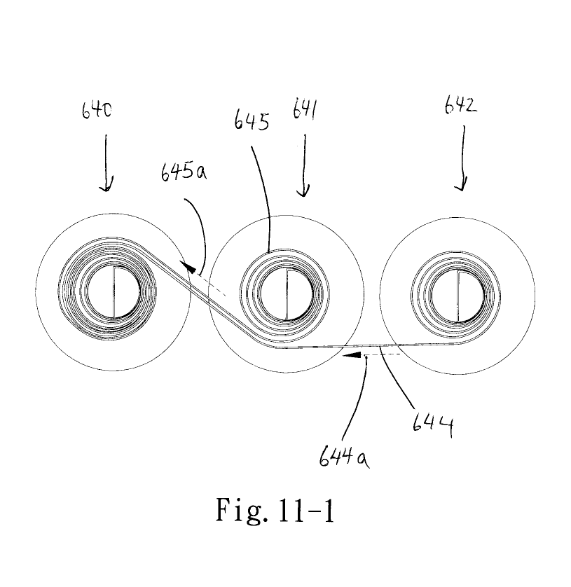

As in FIGS. 11 and 11-1, window covering system 601 has a spring-loaded motor with two springs 644, 645 to bias the same output drum 640 in a clockwise direction to wind connecting cord 613. When a user manually grabs and pulls the bottom member downward to lower the shade, connecting cord 613 unwinds from drum surface 640a of output drum 640, causing Springs 644, 645 to move in the direction of 644a, 645a.

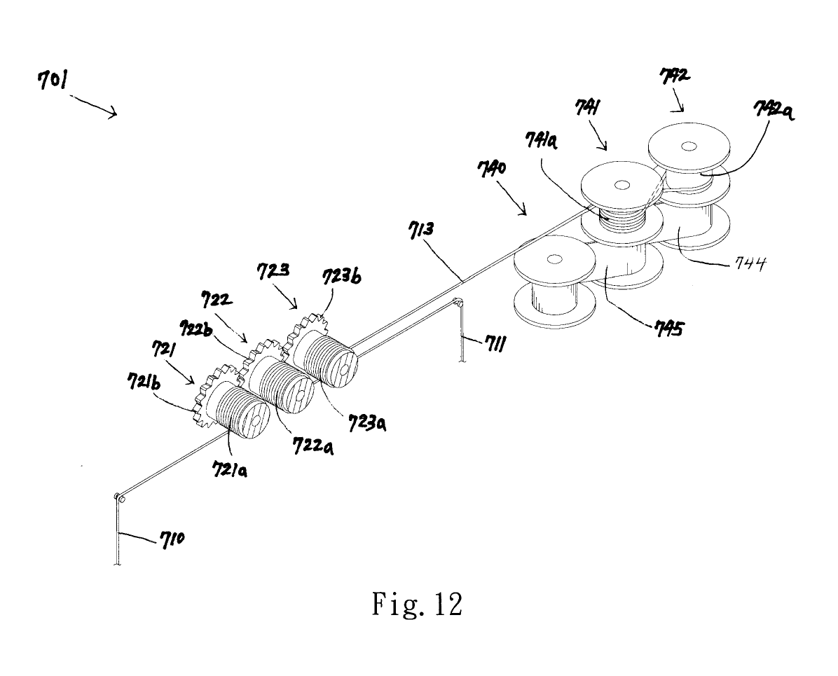

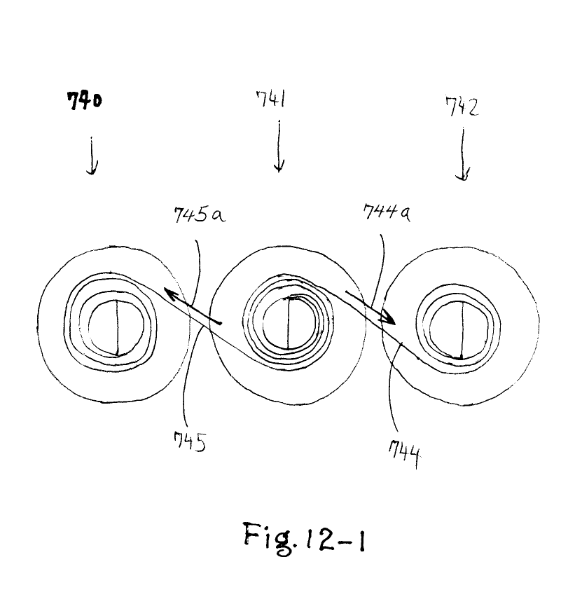

FIGS. 12 and 12-1 illustrate yet another possible design of spring-loaded motor having three drums 740-742 where two S-shaped springs 744, 745 are provided to drive output drum 741 in a clockwise direction looking top down. Springs 744, 745 tend to retrieve in the direction of 744a, 745a, respectively. Here, connecting cord 713 winds around drum surfaces 741a, 742a in a FIG. 8 configuration before being stored on drum surface 741a.

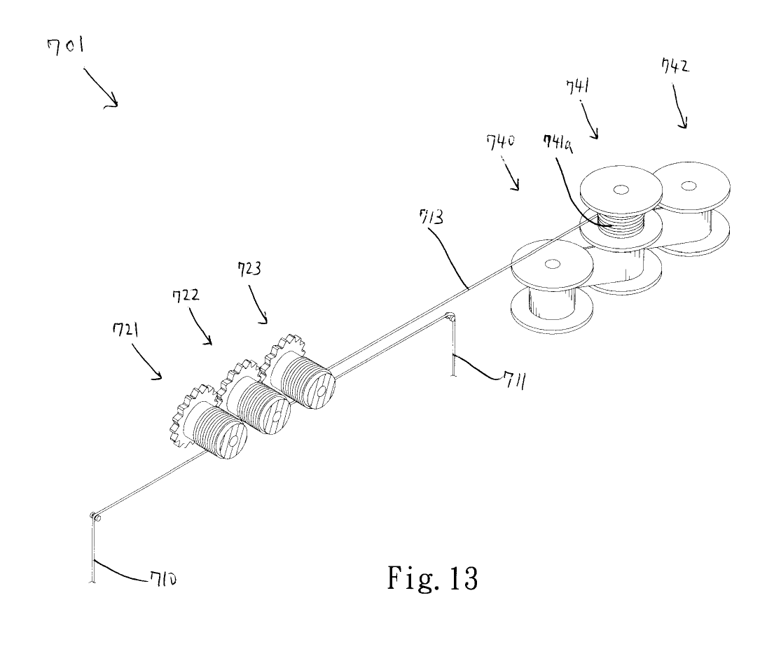

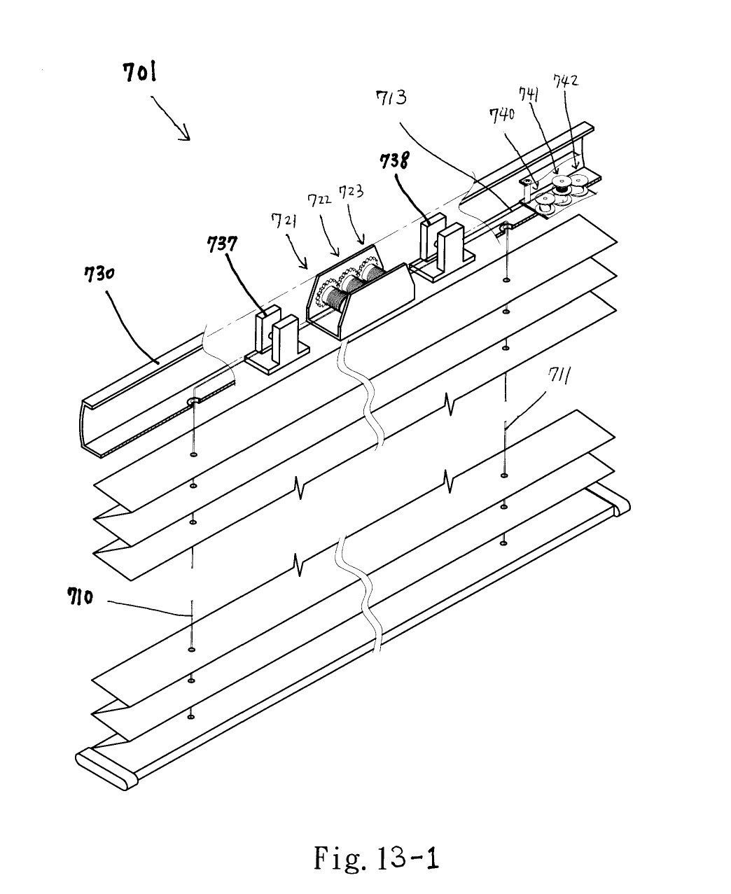

FIGS. 13 and 13-1 show an embodiment similar to that shown in FIGS. 12 and 12-1. The difference here is that connecting cord 713 in FIG. 13 does not wind around two drum surfaces in a FIG. 8 configuration. Here in FIG. 13, only the output drum 741 has a drum surface 741a. As discussed earlier, one of ordinary skill in the art would immediately appreciate the various possible permutations available where connecting cord may wind about anyone, or any of more than one drum surfaces and store on any one of the multiple drum surfaces.

Window covering system 701 in FIG. 13-1 has two lifting cord guides 737, 738 fastened to the head rail 730. Each of the two lifting cord guides 737, 738 has two upright arms to partially surround the lifting cords 710, 711 when the lifting cords 710, 711 pass by the lifting cord guides 737, 738. Lifting cord guides 737, 738 align lifting cords 710, 711 to wind close to the center portion of rotors 721, 722. Having lifting cord guides 737, 738 is preferable in all embodiments disclosed herein because they minimize misalignment of the lifting cords on the rotors, as such misalignment may cause tangling of the lifting cords with the gears. One of ordinary skill in the art would readily appreciate that the lifting cord guides 737, 738 may be formed in other structures configurations to achieve the same result of guiding lifting cords.

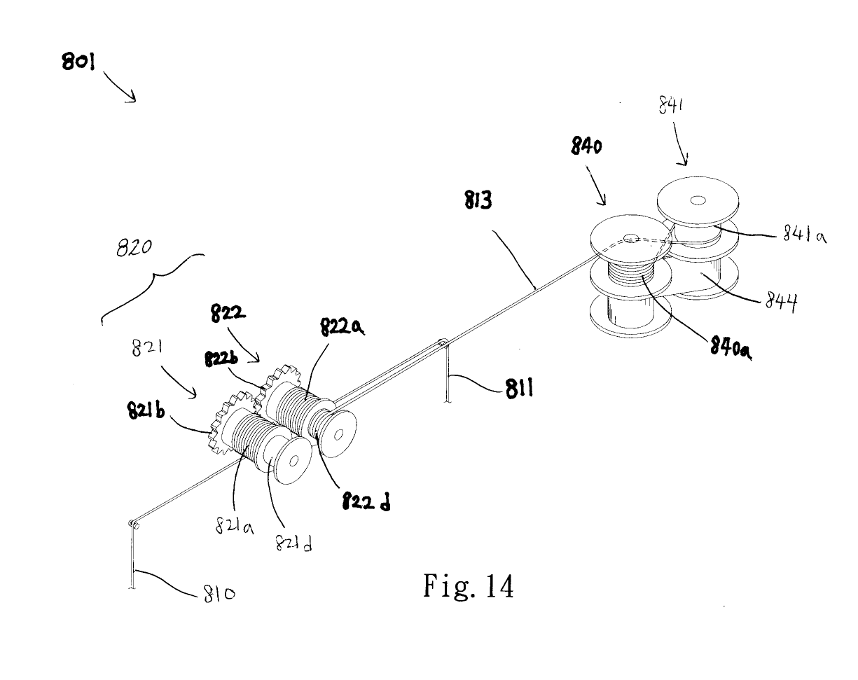

FIG. 14 shows a window covering system 801 having a rotor set 820. Rotors 821, 822 in the rotor set 820 are interconnected by gears 821b, 822b, and each rotor has an extended rotor surface capable of winding and storing lines. In this figure, connecting cord 813 only winds around one extended rotor surface 822d. Rotor 821 has rotor surface 821a for winding and storing lifting cord 810, and has an extended rotor surface 821d that may be used if necessary. Rotor 822 has rotor surface 822a for winding and storing lifting cord 811, and has extended rotor surface 822d for winding connecting cord 813. It should be noted that although FIG. 14 shows that connecting cord 813 does not wind around extended rotor surface 821d, such configuration can be readily appreciated by those with ordinary skilled in the art. As such, connecting cord 813 may also wind about extended rotor surfaces 821d, 822d in a criss-cross configuration.

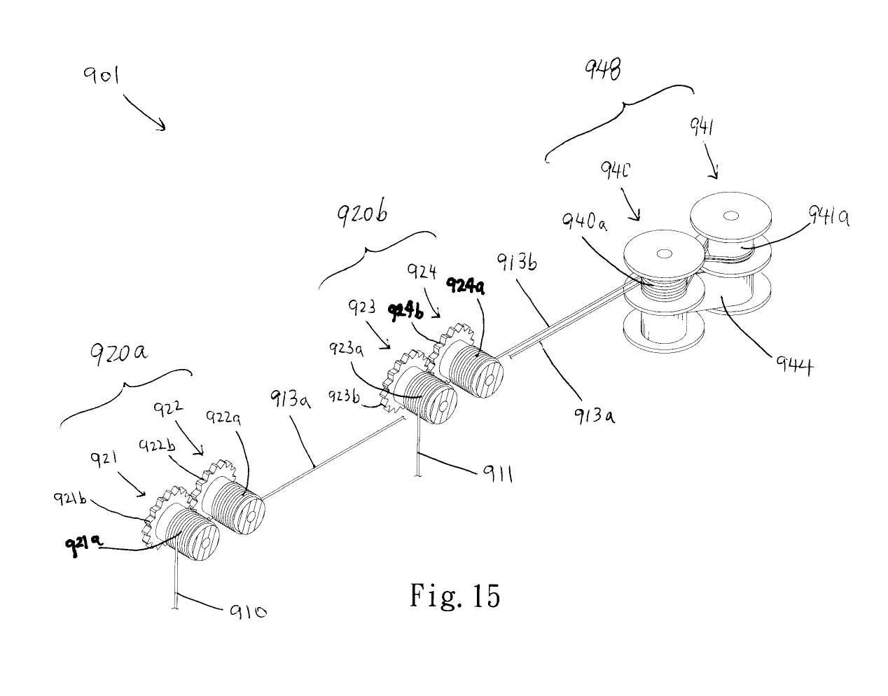

FIG. 15 illustrates a still further contemplated embodiment of the present invention. FIG. 15 shows a window covering system 901 where two connecting cords 913a, 913b lead into spring-loaded motor 948. In this embodiment, two separate rotor sets 920a, 920b correspond to the two connecting cords 913a, 913b, respectively. Rotors 921, 922 of rotor set 920a are connected by gears 921b, 922b. Rotors 923, 924 of rotor set 920b are connected by gears 923b, 924b. Rotors 921, 923 wind lifting cord 910, 911, respectively. Both connecting cords 913a, 913b are driven by the same spring-loaded motor 948, entrain around drums 940, 910 in the same criss-crossed fashion as previously discussed. Output drum 940 and storage drum 941 are coupled by spring 944 to bias output drum 940 to rotate in a line-winding direction. Alternatively, the two connecting cords 913a, 913b may be separately driven by two spring-loaded motors.

Overall, some of the important feature of the present invention includes using gears to interconnect rotors, and using gears to interconnect drums, and using a connecting cord to connect the motor to the rotors. One should appreciate that many permutations of using these gears are available. For example, a further contemplated embodiment may only have gears on some of the drums, and have no gears in the rotors. Or, another embodiment may only have gears on some of the rotors, but no gears in the drums.

With respect to the gear structure, although spur gear is specifically illustrated, one of ordinary skill in the art would ready appreciate that one may also use other types of gears, such as helical gears, bevel gears, worm gears, rack and pinion gears.

With respect to spring-loaded motor, it is typically located within the same channel as the rotor set. All of the Figures and discussion above are based on a design where the channel is the channel of a head rail. Alternatively, the spring-loaded motor and the rotors set may be located in a channel of a bottom elongated member. This design is essentially the upside-down version of the first design. This “bottom” elongated member containing all or most of the components described herein does not fasten to the window frame and is instead hung in mid-air. In this upside-down design, the elongated member along with all of the components in the channel also acts as a weight, eliminating the need to place metal bars (as weight) at the bottom of the shade for stability.

A yet further contemplated embodiment may have the spring-loaded motor located in the head rail, while the rotor set is located in a channel of the bottom elongated member, or vise versa.

Further, as those of ordinary skill in the art will also recognize, the flat S-shaped spring described may readily be modified as dictated by the aesthetic or functional needs of particular applications. It may or may not have constant width and thickness. Contemplated suitable materials for the spring includes, natural and synthetic polymers, various metals and metal alloys, naturally occurring materials, and all reasonable combinations thereof. Other known resilient spring-like device may also be utilized in place of the S-shaped spring to provide resilient force.

Still further contemplated suitable materials for the window covering member includes natural and synthetic polymers, various metals and metal alloys, naturally occurring materials, textile fibers, and all reasonable combinations thereof.

Thus, specific embodiments and applications of Window Shade with Gears have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

What is claimed is:

1. A window covering system comprising:
a first lifting cord;
a first connecting cord;
an elongated member having a channel;
a window covering member having an area of coverage, the window covering member is coupled to the elongated member;
a rotor set disposed within the channel, the rotor set having a first rotor and a second rotor;
an output drum attached to a proximal end of the first connecting cord, and stores a portion of the first connecting cord, said output drum is coupled to a first spring which biases the output drum to wind the first connecting cord in a winding direction;
wherein when said connecting cord moves, said first rotor also rotates;
wherein a proximal end of the first lifting cord is attached to said second rotor, and the first rotor is coupled to said second rotor such that when the first rotor rotates, the second rotor also rotates to wind and store a portion of the first lifting cord, the rotation of said second rotor causes the area of coverage to change in size.

2. The system of claim 1 further comprising a third rotor attached to the proximal end of a second lifting cord and winds and stores a portion of the second lifting cord, and wherein when the first rotor rotates, the third rotor rotates correspondingly which in turn moves the second lifting cord to lift the window covering member.

3. The system of claim 2, wherein each of at least two of the rotors in the rotor set comprises a gear to facilitate gear mesh-gear coupling of the at least two rotors, and wherein the gear is selected from the group consisting of spur gears, helical gears, bevel gears, worm gears, rack and pinion gears.

4. The system of claim 3 further comprising a storage drum, wherein both the output drum and the storage drum have gears coupling both together by spur gear mesh-coupling.

5. The system of claim 4, where both the output drum and the storage drum have drum surfaces capable of entraining said first connecting cord for improved stability as the storage drum winds and stores said first connecting cord.

6. The system of claim 5, wherein the first connecting cord entrains about both the output drum and the storage drum in a criss-cross pattern.

7. The system of claim 3 further comprising an storage drum coupled to said output drum, a third drum attached to a second spring, wherein the second spring also biases said output drum to wind and store said first connecting cord.

8. The system of claim 7, wherein the output drum is disposed between the storage drum and the third drum.

9. The system of claim 3 further comprising an storage drum coupled to the output drum by the first spring, and a third drum disposed between the storage drum and the output drum, bending the first spring and changes a direction of the first spring.

10. The system of claim 9, wherein at least two of the drums have gears and are coupled by gear-meshing.

11. The system of claim 1 further comprising a second connecting cord having a distal end attached to a third rotor, wherein the second connecting cord is driven to rotate the third rotor which in turn rotates a fourth rotor, the fourth rotor is attached to a second lifting cord to lift the window covering member.

12. The system of claim 11 wherein at least two of the four rotors have gears to facilitate gear mesh-coupling of the at least two rotors, and wherein the gear is selected from the group consisting of spur gears, helical gears, bevel gears, worm gears, rack and pinion gears.

13. The system of claim 12, wherein said output drum is a first output drum, and the system further comprising a second output drum driven by a second spring to drive the second connecting cord separately from the first connecting cord.

14. The system of claim 12 further comprising a storage drum, wherein both the output drum and the storage drum have gears coupling both together by gear mesh-coupling.

15. The system of claim 12, wherein a proximal end of the second connecting cord is attached to the output drum, such that the same output drum drives both said first and second connecting cord.

16. The system of claim 1 further comprising a stroage drum, wherein both the output drum and the storage drum have gears coupling both together by spur gear mesh-coupling.

17. The system of claim 1 further comprising a second lifting cord having a proximal end attached to an extended rotor surface of one of the rotors, such that the second lifting cord is wound and stored without contacting any other cords.

18. The system of claim 1 further comprising a line guide disposed within the channel for centering the first lifting cord as it is wound onto the second rotor.

19. The system of claim 1 further comprising a detachable receptacle that contains the output drum, wherein the receptacle is slidably fitted within the channel and can be readily removed from the channel by a consumer.
